(19) United States
(12) Patent Application Publication
(10) Pub. No.: US 2010/0142480 A1
(43) Pub. Date: Jun. 10, 2010

(54) METHOD OF SEAMLESS VERTICAL HANDOVER FOR SDR TERMINAL AND SCA BASED SDR TERMINAL FOR THE SAME

(75) Inventors: Hwansouk YOO, Daejeon (KR); Namhoon Park, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/631,184

(22) Filed: Dec. 4, 2009

(30) Foreign Application Priority Data
Dec. 5, 2008 (KR) 10-2008-0123484
Nov. 13, 2009 (KR) 10-2009-0109611

(51) Int. Cl. H04W 4/00

(52) U.S. Cl. 370/331

(57) ABSTRACT

The present invention provides a method of seamless vertical handover for an SDR terminal and an SCA based SDR terminal for the same. A method of seamless vertical handover for an SDR terminal of the present invention includes: determining whether a download of a waveform application related to a peripheral access network is needed by collecting peripheral access network information prior to requesting vertical handover; if it is determined that the download is needed, downloading and storing the waveform application; and performing the seamless vertical handover using the pre-stored waveform application upon request the vertical handover. Therefore, the seamless vertical handover for the SDR terminal can be efficiently performed.

### RELATED APPLICATIONS

The present application claims priority to Korean Patent Application Serial Number 10-2008-0123484, filed on Dec. 5, 2008 and Korean Patent Application Serial Number 10-2009-0109611, filed on Nov. 13, 2009, the entirety of which are hereby incorporated by reference.

### BACKGROUND OF THE INVENTION

1. Field of the Invention

The present invention relates to an SCA (Software Communications Architecture) based SDR (Software Defined Radio) terminal, and in particular, to a method of vertical handover for an SDR terminal.

2. Description of the Related Art

An SDR (Software Defined Radio) is a technology that can use various wireless communication services by executing software in one wireless device. To this end, in an SDR terminal, all or a part of components that perform functions related to communication are implemented by software, unlike a hardware based terminal such as an application specific integrated circuit (ASIC). The SDR terminal should execute waveform applications in order to provide communication services. Generally, since the waveform application is first loaded and then executed, the SDR terminal requires longer service standby time than a hardware based terminal such as ASIC, etc., such that it may be difficult to quickly provide services when the services are changed.

In the viewpoint of the SDR terminal, vertical handover means changing from currently used waveform applications to other waveform applications. Therefore, for the vertical handover, the SDR terminal should change the waveform application, such that the existing waveform applications should be uninstalled and new waveform applications should be installed. However, a considerable time is consumed in this process and therefore, the seamless vertical handover cannot be easily made in the SDR terminal.

An SCA (Software Communications Architecture) is standardized communication software architecture proposed in order to largely improve interoperability between communication systems and reduce development and disposition expense. The SCA adopts COBRA (Common Object Request Architecture), which is an industrial standard of a real-time operating system, and a distributed object model as middleware, to provide an integrated environment having different kinds of hardware and software. The SDR system adopts the SCA as a standard of a software framework.

FIG. 1 is a block diagram of an SCA based SDR terminal according to the related art.

Referring to FIG. 1, an SDR terminal 100 includes a domain manager 110, a device manager 120, a file manager 130, an application factory 140, various devices 1450, a file system 160, and a waveform application 170.

The domain manager 110 generally manages the operations of the SDR terminal 100.

The device manager 120 controls various devices 150.

The various devices 150 may include a DSP device, an FPGA device, a GPP device, etc., as shown in FIG. 1.

The file manager 130 manages the file system 160 in the SDR terminal 100.

The application factory 140 controls the waveform application 170 of the SDR terminal 100. In other words, the application factory 140 can perform the install and uninstall of the waveform application 170.

The waveform application 170 is executed in order to provide the communication services of the SDR terminal 100. When the vertical handover is generated, the waveform application 170 should be updated into a new waveform application.

A media independent handover (MIH), in which research is actively being pursued at the IEEE (Institute of Electrical and Electronics Engineers) (802.21 standard), is a technology that provides seamless handover to terminals so that the terminals having multi wireless interfaces such as wireless LAN of IEEE 802.11 standard, Wibro of IEEE 802.16 standard, WCDMA (Wideband Code Division Multiple Access), CDMA-2000 (Code Division Multiple Access 2000), etc., can cross between different media, thereby making it possible to receive various application services such as voice, data, multimedia, etc. The media independent handover is realized by performing information exchange for handover between the terminal and the base station by using an event service, a command service, and an information service.

Consequently, a need exists for a new method of seamless vertical handover for the SDR terminal, which can quickly change the waveform application in the SDR terminal in order to perform the seamless vertical handover while ensuring compatibility with the IEEE 802.21 standard.

### SUMMARY OF THE INVENTION

The present invention proposes to solve the above-mentioned problems of the related art. It is an object of the present invention to perform seamless vertical handover by reducing time consumed to reconfigure waveform applications of an SDR terminal in the vertical handover.

In addition, it is another object of the present invention to provide a method of seamless vertical handover for an SDR terminal having better expandability by being compatible with the IEEE 802.21 standard.

Further, it is yet another object of the present invention to reduce power consumption while performing seamless vertical handover by quickly performing the install of new applications and the uninstall of existing applications upon performing the vertical handover to minimize a multi mode operation time.

A method of seamless vertical handover for an SDR terminal according to one embodiment of the present invention includes: determining whether a download of a waveform application related to a peripheral access network is needed by collecting peripheral access network information prior to requesting vertical handover; if it is determined that the download is needed, downloading and storing the waveform application; and performing the seamless vertical handover using the pre-stored waveform application upon requesting the vertical handover.

At this time, the peripheral access network information is collected using a media independent information service (MIIS) and the vertical handover request can be identified using a media independent event service (MIES) or a media independent command service (MICS).

At this time, the media independent information service provides information element that represents the connection information of a waveform application repository server and the downloading and storing the waveform application can download the waveform applications by connecting to the waveform application repository server using the information elements.

At this time, the waveform application related to the peripheral access network may be the waveform application usable in the access network corresponding to a network type information element provided by the media independent information service.

In addition, an SCA based SDR terminal according to one embodiment of the present invention includes: a media independent handover resource that provides functions of a media independent information service (MIIS), a media independent command service (MICS), and a media independent event service (MIES); a waveform application manager that downloads and stores a waveform application required prior to a vertical handover request and installs the pre-stored waveform application upon request of the vertical handover; and a media independent handover manager that controls the waveform application manager based on the media independent information service and the media independent event service.

At this time, the media independent information service provides information elements that represent connection information of a waveform application repository server and the waveform application manager downloads the waveform applications by connecting to the waveform application repository server using the information element.

At this time, the media independent handover manager can control the waveform application manager to identify the vertical handover request based on event and commands provided by the media independent event service or the media independent command service and to install the pre-stored waveform application upon request of the vertical handover.

At this time, the media independent handover manager can control the waveform application manager that identifies whether the vertical handover completes based on a link events or commands provided by the media independent event service or the media independent command service and if it is determined that the vertical handover is completes, uninstalls the existing waveform application.

The following effects can be obtained by the present invention.

With the present invention, it can reduce the time consumed to reconfigure the waveform applications upon performing the vertical handover for the SDR terminal to perform the seamless vertical handover.

In addition, the present invention can provide the method of seamless vertical handover for the SDR terminal having better expandability by being compatible with IEEE 802.21 standard.

Further, the present invention can reduce power consumption while performing the seamless vertical handover by quickly performing the install of the new applications and the uninstall of the existing applications upon performing the vertical handover to minimize the multi mode operation time.

### BRIEF DESCRIPTION OF THE DRAWINGS

FIG. 1 is a block diagram of an SCA based SDR terminal according to the related art;

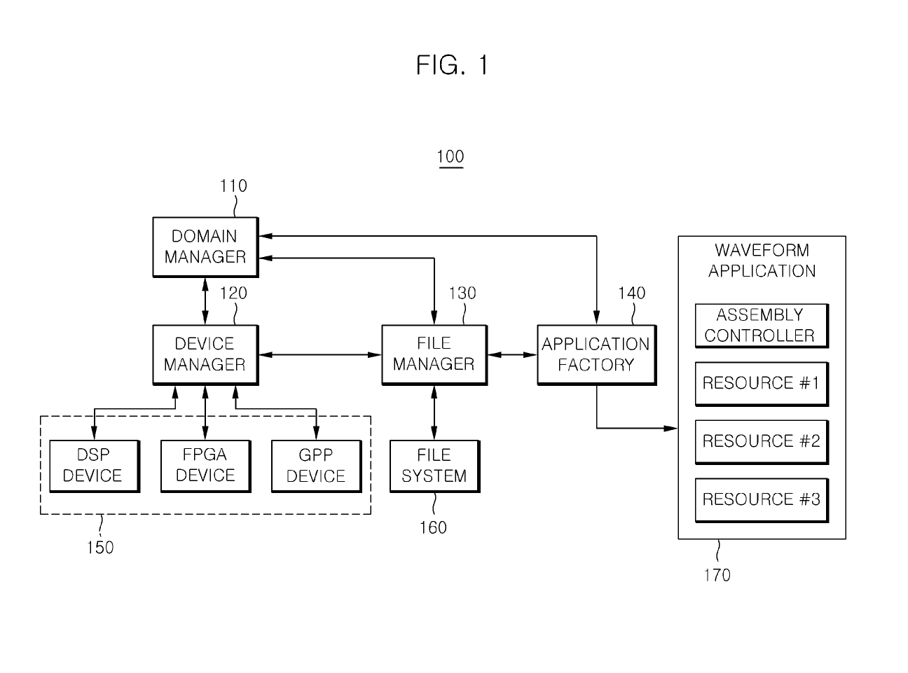

FIG. 2 is a block diagram of an SCA based SDR terminal according to one embodiment of the present invention;

FIG. 3 is a block diagram showing the waveform application download operation of the SCA based SDR terminal shown in FIG. 2;

FIG. 4 is a diagram showing one example of information elements according to one embodiment of the present invention;

FIG. 5 is a block diagram showing the multi mode operations of the SCA based SDR terminal according to one embodiment of the present invention;

FIG. 6 is an operational flowchart showing a method of seamless vertical handover for the SDR terminal according to one embodiment of the present invention; and

FIG. 7 is an operational flowchart showing one example of the vertical handover steps shown in FIG. 6.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the drawings may be exaggerated for explicit comprehension.

Hereinafter, exemplary embodiments of the present invention will be described in detail with reference to the accompanying drawings.

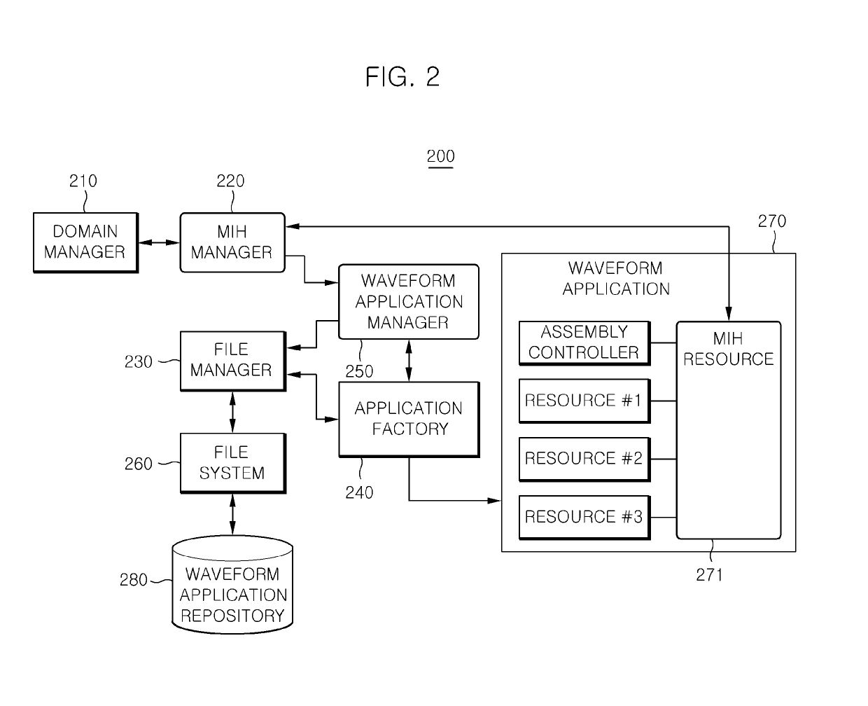

FIG. 2 is a block diagram of an SCA based SDR terminal according to one embodiment of the present invention.

Referring to FIG. 2, the SCA based SDR terminal according to one embodiment of the present invention includes a domain manager 210, a media independent handover manager 220, a file manager 230, an application factory 240, a waveform application manager 250, a file system 260, a waveform application 270, and a waveform application repository 280.

The domain manager 210 generally manages the operation of the SCA based SDR terminal 200. Although not shown in FIG. 2, the domain manager 210 can transmit and receive the signal from and to the waveform application manager 250 and the application factory 240, etc.

In particular, when the domain manager 210 receives an install request of a new waveform application from the waveform application manager 250, it can generate a new application factory to generate the new waveform application.

In addition, when the domain manager 210 receives an uninstall request of the waveform application from the waveform application manager 250, it can transmit the request to the application factory 240.

The media independent handover manager 220 corresponds to a media independent handover (MIH) user in MIH architecture and receives access network information through media independent information service (MIIS) of a media independent handover (MIH) function and transmits it to the waveform application manager 250, such that the waveform application manager 250 searches whether the waveform application for using the corresponding network is stored in the waveform application repository 280 in the SDR terminal 200 and if it is determined that the waveform application for using the corresponding network is not stored in the waveform application repository 280, accesses a waveform application repository server defined by an information element of the MIIS to download a new waveform application file and is stored in the waveform application repository 280.

In addition, when the media independent handover manager 220 receives a media independent event service (MIES), it selects the waveform application to be newly installed and transmits commands regarding the install of the new waveform application to the waveform application manager 250.

When the media independent handover manager 220 receives a specific MIH link event or an MIH command, it is determined that the handover is completed and can request the waveform application manager 250 to uninstall the existing waveform application.

The file manager 230 manages the file system 260 in the SCA based SDR terminal 200.

The file system 260 manages the waveform application file that is stored in the waveform application repository 280.

In particular, when the file manager 230 requires the generation of the new application, the waveform application file in the waveform application repository 280 can be provided to the application factory 240, etc.

The application factory 240 controls the waveform application 270 of the SCA based SDR terminal 200. In other words, the application factory 240 can perform the install and uninstall of the waveform application 270.

The waveform application manager 250 receives the specific information elements of the MIIS or the signals generated using the information element through the media independent handover manager 220 and analyzes them, thereby confirming whether the waveform application usable in a peripheral access network is stored in the waveform application repository 280.

When the waveform application manager 250 does not store the necessary waveform application, it receives the necessary waveform application and stores it in the waveform application repository 280, in a waveform application repository server that is described in the information elements (waveform application server specific information elements) that represents the connection information of the waveform application repository server of the MIIS.

Further, the waveform application manager 250 confirms whether the corresponding waveform application exists in the waveform application repository 280 when the vertical handover request is identified by the MIES or MICS, and then requests the domain manager 210 to install the new waveform application.

Moreover, when the waveform application manager 250 requests the uninstall of the waveform application from the media independent handover manager 220, it can transmit the request to the domain manager 210.

The waveform application 270 is executed to provide communication services of the SCA based SDR terminal 200. When the vertical handover is generated, the new waveform application 270 should be also updated into the waveform application.

In particular, the waveform application 270 includes the media independent handover resource 271. At this time, the media independent handover resource 271 corresponds to the media independent handover (MIH) function.

The media independent handover resource 271 provides the MIIS and MIES functions and when it receives the MIIS or MIES, transmits the MIIS or MIES to the media independent handover manager 220.

At this time, the media independent handover resource 271 can receive the MIH event related to the handover such as MIH_Link_Detected, MIH_Link_UP, MIH_Link_Down, or MIH_Link_Handover_Complete, etc., and MIH command such as MIH_N2N_HO_Commit, MIH_MN_HO_Commit, MIH_Net_HO_Complete, MIH_N2N_HO_Complete, etc., which are defined by the IEEE 802.21 standard, to transmit them to the media independent handover manager 220. The process for MIH user to receive the MIH event follows a scheme defined in an IEEE 802.21 technical standard.

The MIH user, MIH function, MIIS, MIES, and MICS, etc., is described in detail in a web document such as a submission tree page, etc., of IEEE 802.21 technical standard discussion group website (http://www.ieee802.org/21/).

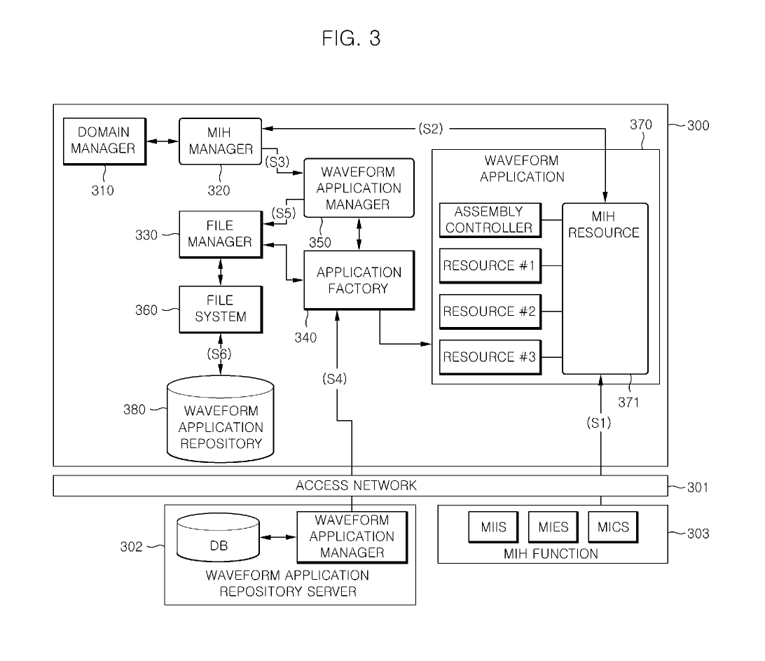

FIG. 3 is a block diagram showing the waveform application download operation of the SCA based SDR terminal shown in FIG. 2.

Referring to FIG. 3, the SCA based SDR terminal 300 receives the peripheral access network information through the MIIS (s1).

At this time, the MIIS can be transmitted through the access network 301 from a server 303 having the MIH function.

The media independent handover resource 371 transmits the received MIIS to the media independent handover manager 320 (S2).

The media independent handover manager 320 transmits the information elements, which represents the network type in the MIIS, to the waveform application manager 350 (s3). At this time, the information element representing the network type is the information element, which can uniquely identify the waveform application such as IE_NETWORK_TYPE, IE_SERVICE_PROVIDER_ID, etc., which is defined by the IEEE 802.21 standard.

The waveform application manager 350 searches the waveform application repository 380 to confirm whether the useable waveform application is stored in the access network corresponding to the information element that represents the network type. At this time, the waveform application repository 380 can search the waveform application repository 380 through the file manager 330.

When the necessary waveform application is not stored, it can obtain the connection information of the waveform application repository server 302 using the information element that represents the connection information of the waveform application repository server provided through the MIIS. At this time, the connection information may be an IP address.

The waveform application downloaded from the waveform application repository server 302 is stored in the waveform application repository 380. At this time, the downloaded waveform application may be stored in the waveform application repository 380 through any one of the application factory 340, the waveform application manager 350, the file manager 330, and the file system 360 (S4, S5, and S6).

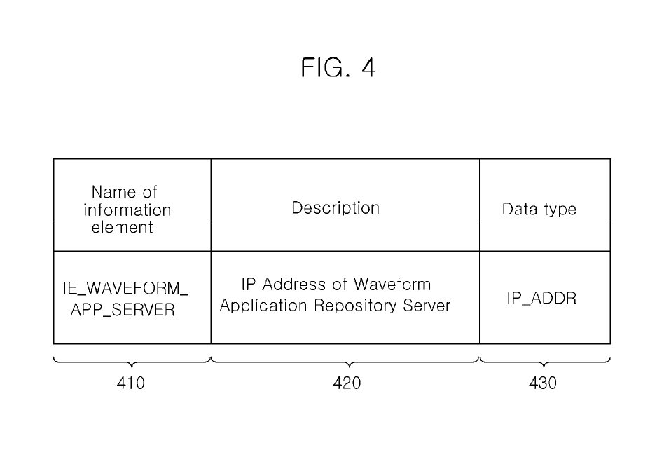

FIG. 4 is a diagram showing one example of the information element according to one embodiment of the present invention.

Referring to FIG. 4, the information element representing the connection information of the waveform application repository server according to one embodiment of the present invention is added to the MIIS.

This information element may include a first field 410 that represents a name of the information element, a second field 420 that represents a description about the information element, and a third field 430 that represents the connection information such as the IP address, etc., of the waveform application repository server.

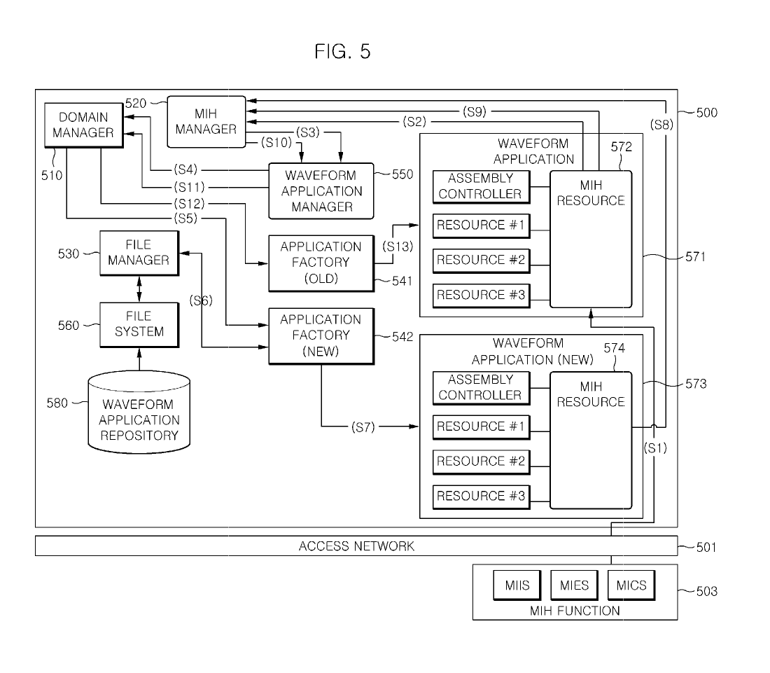

FIG. 5 is a block diagram of a multi-mode operation of the SCA based SDR terminal according to one embodiment of the present invention.

At this time, the multi-mode may mean the operation mode that the SDR terminal simultaneously has two or more waveform applications.

Referring to FIG. 5, an SCA based SDR terminal 500 receives the vertical handover request through the media independent event service (MIES) or the media independent command service (MICS) (S1).

At this time, the MIES can be provided through the access network 503 from the server 501 having the MIH function at the remote place.

The media independent handover resource 572 transmits the event corresponding to the received vertical handover request to the media independent handover manager 520 (S2).

The media independent handover manager 520 selects the waveform application to be newly installed based on the MIIS information and transmits the command regarding the install of the new waveform application to the waveform application manager 550 (S3).

The waveform application manager 550 confirms whether the corresponding waveform application exists in the waveform application repository 580 and then, requests the domain manager 510 to install the new waveform application (S4).

The domain manager 510 generates the new application factory 542 for generating the new waveform application (S5).

In order to generate the new waveform application, the file of the waveform application requests the file manager 530 and the corresponding file is provided from the waveform application repository 580 (S6).

The application factory 542 receiving the file generates the new waveform application 573 (S7).

When receiving the MIH link event such as MIH_Link_Detected, MIH_Link_UP, etc., that are defined by the IEEE 802.21 standard in the media independent handover resource 574 of the new waveform application 573, this is transmitted to the media independent handover manager 520 (S8).

When receiving the MIH link events such as MIH_Link_Down, MIH_Link_Handover_Complete, etc., that are defined by the IEEE 802.21 standard in the media independent handover resource 572 of the existing waveform application 571 or the MIH commands such as MIH_N2N_HO_Commit, MIH_MN_HO_Commit, MIH_Net_HO_Complete, MIH_N2N_HO_Complete, etc., this is transmitted to the media independent handover manager 520 (S9).

When the media independent handover manager 520 receives the specific MIH link event such as MIH_Link_Detected, MIH_Link_UP, MIH_Link_Down, MIH_Link_Handover_Complete, etc., that are defined through IEEE 802.21 or when receiving the MIH commands such as MIH_N2N_HO_Commit, MIH_MN_HO_Commit, MIH_Net_HO_Complete, MIH_N2N_HO_Complete, etc., it is determined that the handover is completed and requests the application manager 550 to uninstall the existing waveform application 571 (S10).

The waveform application manager 550 requests the domain manager 510 to uninstall the waveform application 571 (S11).

The domain manager 510 requests the application factory 541 to uninstall the waveform application 571 (S12).

The application factory 541 uninstalls the waveform application 571 (S13).

Thereafter, the domain manager 510 uninstalls the application factory 541.

Therefore, the SCA based SDR terminal is operated as a multi-mode during the vertical handover process and then operated as a single mode terminal after the handover is completed. Further, the latency generated upon reconfiguring the waveform application of the SDR terminal can be reduced and thus, the seamless vertical handover can be achieved.

Consequently, this is possible since the SDR obtains the information related to the vertical handover using the IEEE 802.21 standard to prepare procedures regarding the handover beforehand by using a proactive scheme. In other words, a process required to reconfigure the waveform application using the MIIS is previously performed and when the process waits until the MIES event or the MICS command is received and then, receives the MIES event or the MICS command, it quickly starts the new waveform application in order to perform the vertical handover. Since the time consumed to change the waveform application in this scheme is minimized, the seamless vertical handover can be performed.

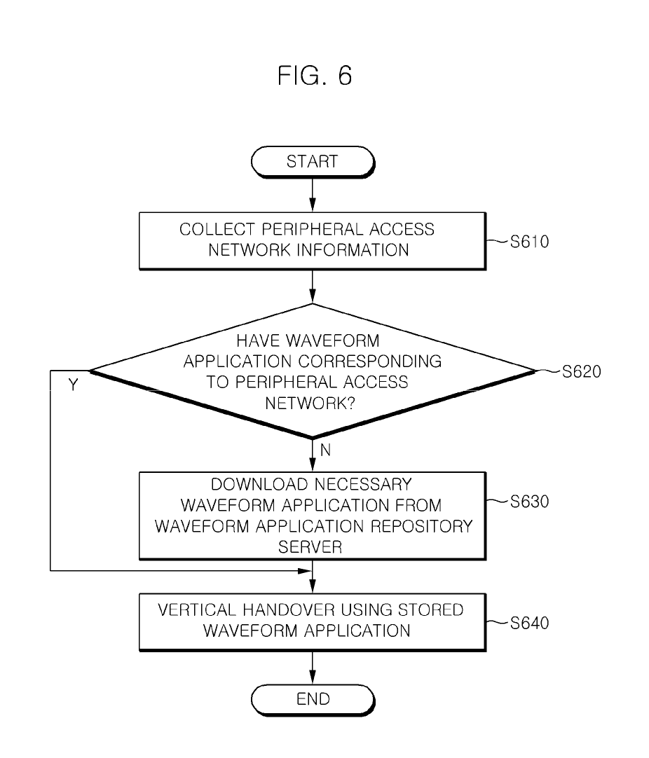

FIG. 6 is an operational flowchart showing the method for seamless vertical handover for the SDR terminal according to one embodiment of the present invention.

Referring to FIG. 6, the method for seamless vertical handover for the SDR terminal according to one embodiment of the present invention first collects the peripheral access network information prior to the vertical handover request (S610).

At this time, the peripheral access network information is collected using a media independent information service (MIIS) and the vertical handover request can be identified using a media independent event service (MIES) or a media independent command service (MICS).

In addition, the method for seamless vertical handover for the SDR terminal uses the collected peripheral access network information to confirm whether the waveform application corresponding to the peripheral access network is stored in the SDR terminal (S620). At this time, when the corresponding waveform application is not stored in the SDR terminal, it can be determined that the download is required.

At this time, the waveform application corresponding to the peripheral access network may be the waveform application usable in the access network corresponding to a network type information element provided by the media independent information service. At this time, the network type information elements may be IE_NETWORK_TYPE defined by the IEEE 802.21 standard.

When it is determined that the download is required, the method for seamless vertical handover for the SDR terminal downloads the corresponding waveform application in the waveform application repository server and stores it in the SDR terminal (S630).

At this time, the information element, which represents the connection information of the waveform application repository server, can be provided by the media independent information service. At this time, step (S630) uses the information element to access the waveform application repository server, thereby making it possible to download the waveform application.

In this case, the connection information of the waveform application repository server may be an IP address.

In addition, the method of seamless vertical handover for the SDR terminal uses the stored waveform application to perform the seamless vertical handover (S640).

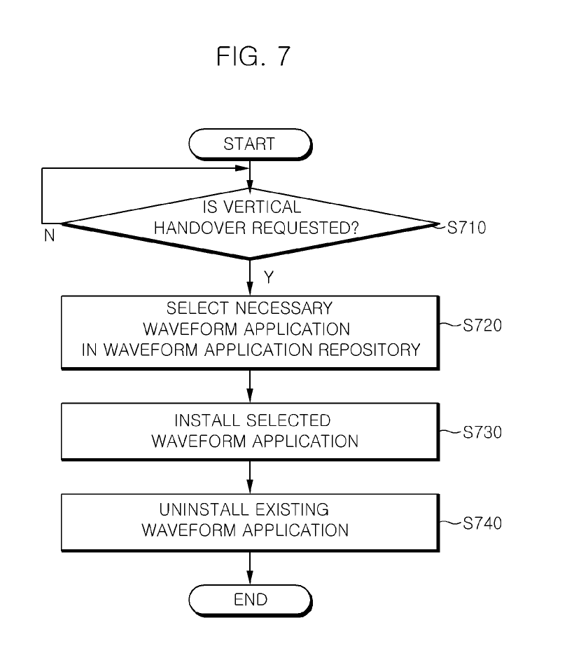

FIG. 7 is an operational flowchart showing one example of the vertical handover step (S640) shown in FIG. 6.

Referring to FIG. 7, step (S640), which performs the seamless vertical handover using the stored waveform application shown in FIG. 6, first identifies the vertical handover request (S710).

At this time, the vertical handover request can be identified based on the events provided by the media independent event service (MIES).

The step of performing the seamless vertical handover does not progress the next step if it is determined that there is no vertical handover request. At this time, if it is determined that there is no vertical handover request, the step of performing the seamless vertical handover may progress to the step (S610) of collecting the peripheral network information shown in FIG. 6.

If it is determined that there is the vertical handover request, the step of performing the seamless vertical handover selects the necessary waveform application within the waveform application repository in the SDR terminal (S720).

In addition, the step of performing the seamless vertical handover newly installs the selected waveform application (S730).

Further, the step of performing the seamless vertical handover uninstalls the existing waveform application (S740).

At this time, the uninstall of the existing waveform application may be performed according to the completion or not of the vertical handover identified based on the link event provided by the media independent event service.

The waveform application download operation and the multi-mode operation of the SCA based SDR terminal, which are described through FIGS. 3 to 5, can be applied to the method for seamless vertical handover of the SDR terminal shown in FIGS. 6 and 7 and in order to avoid the repeated description, the description thereof will be omitted.

Each step shown in FIGS. 6 and 7 can be performed in an order shown in FIGS. 6 and 7, and vice versa or simultaneously.

Some steps of the present invention can be implemented as a computer-readable code in a computer-readable recording medium. The computer-readable recording media include all types of recording apparatuses in which data that can be read by a computer system is stored. Examples of the computer-readable recording media may include a ROM, a RAM, a CD-ROM, a CD-RW, a magnetic tape, a floppy disk, an HDD, an optical disk, an optical magnetic storage, etc., and in addition, can be implemented in the form of a carrier wave (for example, transmission through the Internet). Further, the computer-readable recording media are distributed on computer systems connected through the network, and thus may be stored and executed as the computer-readable code by a distribution scheme.

As described above, the preferred embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method of seamless vertical handover for an SDR terminal, comprising:
determining whether a download of a waveform application related to a peripheral access network is needed by collecting peripheral access network information prior to requesting vertical handover;
if it is determined that the download is needed, downloading and storing the waveform application; and
performing the seamless vertical handover using the pre-stored waveform application upon requesting the vertical handover.

2. The method of seamless vertical handover for an SDR terminal according to claim 1, wherein the peripheral access network information is collected using a media independent information service (MIIS) and the vertical handover request is identified using a media independent event service (MIES) or a media independent command service (MICS).

3. The method of seamless vertical handover for an SDR terminal according to claim 2, wherein the media independent information service provides information element that represents the connection information of a waveform application repository server, and
the downloading and storing the waveform application downloads the waveform applications by connecting to the waveform application repository server using the information elements.

4. The method of seamless vertical handover for an SDR terminal according to claim 3, wherein the connection information of the waveform application repository is a server with an IP address.

5. The method of seamless vertical handover for an SDR terminal according to claim 2, wherein the waveform application related to the peripheral access network is the waveform application usable in the access network corresponding to a network type information element provided by the media independent information service.

6. The method of seamless vertical handover for an SDR terminal according to claim 2, wherein the performing the vertical handover includes installing the pre-stored waveform application and uninstalling the existing waveform application based on events or commands provided by the media independent event service or the media independent command service.

7. An SCA based SDR terminal, comprising:
a media independent handover resource that provides functions of a media independent information service (MIIS), a media independent event service (MIES), and a media independent command service (MICS);
a waveform application manager that downloads and stores a waveform application required prior to a vertical handover request and installs the pre-stored waveform application upon requesting the vertical handover; and
a media independent handover manager that controls the waveform application manager based on the media independent information service, the media independent event service, and the media independent command service.

8. The SCA based SDR terminal according to claim 7, further comprising a waveform application repository that stores the downloaded waveform application.

9. The SCA based SDR terminal according to claim 7, wherein the media independent information service provides information elements that represent connection information of a waveform application repository server, and
the waveform application manager downloads the waveform application by connecting to the waveform application repository server using the information element.

10. The SCA based SDR terminal according to claim 9, wherein the information element includes an IP address of the application repository server.

11. The SCA based SDR terminal according to claim 7, wherein the media independent handover manager controls the waveform application manager to identify the vertical handover request based on events or commands provided by the media independent event service or the media independent command service and to install the pre-stored waveform application upon requesting the vertical handover.

12. The SCA based SDR terminal according to claim 7, wherein the media independent handover manager controls the waveform application manager to identify whether the vertical handover completes based on events or commands provided by the media independent event service or the media independent command service and if it is determined that the vertical handover completes, to uninstall the existing waveform application.

13. The SCA based SDR terminal according to claim 7, wherein the waveform application manager sets one of the waveform applications useable for an access network corresponding to the network type information element provided by the media independent information service to the necessary waveform application.
